(19) United States
(12) Patent Application Publication
(10) Pub. No.: US 2025/0371103 A1
(43) Pub. Date: Dec. 4, 2025

(54) Tensor Circuits And Methods For Multiplying With Sparse Weights

(71) Applicant: Altera Corporation, San Jose, CA (US)

(72) Inventors: Martin Langhammer, Salisbury (GB); Ilya Ganusov, San Jose, CA (US); Daksha Sharma, Hillsboro, OR (US)

(73) Assignee: Altera Corporation, San Jose, CA (US)

(21) Appl. No.: 19/297,343

(22) Filed: Aug. 12, 2025

(51) Int. Cl. G06F 17/16

(52) U.S. Cl. CPC G06F 17/16

(57) ABSTRACT

A tensor circuit includes first storage circuits coupled to store first activation values from an activation matrix, second storage circuits coupled to store second activation values from the activation matrix, multiplexer circuits configurable to output a subset of the first and the second activation values stored in the first and the second storage circuits, multiplier circuits coupled to multiply weight values from a sparse weight matrix by the subset of the first and the second activation values output by the multiplexer circuits to generate products, and a summation circuit coupled to sum the products.

### BACKGROUND

Configurable integrated circuits can be configured by users to implement desired custom logic functions. In a typical scenario, a logic designer uses computer-aided design (CAD) tools to design a custom circuit design. When the design process is complete, the computer-aided design tools generate configuration data containing configuration bits. The configuration data is then loaded into configuration memory elements that configure configurable logic circuits in the integrated circuit to perform the functions of the custom circuit design. Configurable integrated circuits can be used for co-processing in big-data or fast-data applications. For example, configurable integrated circuits can be used for application acceleration tasks in a datacenter and can be reprogrammed during datacenter operation to perform different tasks.

### BRIEF DESCRIPTION OF DRAWINGS

FIG. 1 is a diagram that illustrates examples of a weight matrix that includes sparse weights, an activation matrix that includes dense activations, and an output matrix.

FIG. 2 is a diagram that illustrates an example of a tensor circuit block that includes multiplexer circuits, multiplier circuits, and a summation circuit block.

FIG. 3 is a diagram that illustrates another example of a tensor circuit block that includes multiplexer circuits, multiplier circuits, and summation circuit blocks.

FIG. 4 is a diagram that illustrates an example of a tensor circuit block that can multiply activation values in an activation matrix by weight values in a sparse weight matrix in a structured sparsity mode.

FIG. 5 is a diagram that illustrates examples of 6 different combinations of 4:2 structured sparsity for a matrix and examples of 3-bit binary codes that encode these 6 combinations.

FIG. 6 is a diagram that illustrates another example of a tensor circuit block that can multiply activation values in an activation matrix by weight values in a sparse weight matrix in a structured sparsity mode.

FIG. 7 is a diagram that illustrates an example of an alternating input sequence of activation values loaded into the register circuits in the tensor circuit block of FIG. 6 during the structured sparsity mode.

FIG. 8 is a diagram that illustrates an example of a tensor circuit block that can multiply activation values in an activation matrix by weight values in a weight matrix in a structured sparsity mode or in a dense mode.

FIG. 9 is a diagram of an illustrative example of a configurable integrated circuit (IC).

FIG. 10A illustrates a block diagram of a system that can be used to implement a circuit design to be programmed into a programmable logic device using design software.

FIG. 10B is a diagram that depicts an example of a programmable logic device that includes fabric dies and base dies that are connected to one another via microbumps.

FIG. 11 is a block diagram illustrating a computing system configured to implement one or more aspects of the embodiments described herein.

### DETAILED DESCRIPTION

Sparsity involves effectively placing zeros into a set of weights of an artificial intelligence (AI) model. Sparsity can reduce the number of multipliers significantly in an AI model, or alternately, increase the performance of an AI model with the same number of multipliers. In a field programmable gate array (FPGA), routing to multipliers is typically a critical resource, often the most critical resource.

In 4:2 structured sparsity, 2 out of every 4 weights in an AI model are zeroed via retraining. An FPGA can implement 4:2 structured sparsity using tensor circuit blocks supported by multiplexers in soft logic. However, using the most optimal structure supported by programmable logic blocks in an FPGA and packing with fractal synthesis may require a large amount of logic and routing wires. For example, a reduction in the amount of digital signal processing (DSP) blocks may be offset by a corresponding increase in the resources (e.g., routing) used to implement structured sparsity.

According to some examples disclosed herein, a tensor circuit block is provided that uses structured sparsity for performing matrix calculations. The tensor circuit block stores activations from an activation matrix in registers. Weights from a structured sparse weight matrix are streamed into the tensor circuit block in real time through inputs without being stored in the tensor circuit block. The tensor circuit block applies sparsity indices to the activations stored in the registers. The tensor circuit block includes multiplexer circuits that align the activations with the weights using the sparsity indices. The tensor circuit block includes multipliers that multiply the weights by the activations to generate products that are summed together by a summation block.

In some implementations, a tensor circuit block is configurable to function in a dense mode or in a sparse mode. In the dense mode, the tensor circuit block multiplies weights from a weight matrix that are dense by activations from an activation matrix. In the sparse mode, the tensor circuit block multiplies weights from a weight matrix that are sparse by activations from an activation matrix. In these implementations, the tensor circuit block can have different sets of multiplexer circuits that make the dense and sparse modes interchangeable.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Throughout the specification, and in the claims, the term “connected” means a direct electrical connection between the circuits that are connected, without any intermediary devices. The term “coupled” means either a direct electrical connection between circuits or an indirect electrical connection through one or more passive or active intermediary devices that allows the transfer of information between circuits. The term “circuit” may mean one or more passive and/or active electrical components that are arranged to cooperate with one another to provide a desired function.

This disclosure discusses integrated circuit devices, including configurable (programmable) logic integrated circuits, such as field programmable gate arrays (FPGAs). As discussed herein, an integrated circuit (IC) can include hard logic and/or soft logic. The circuits in an integrated circuit device (e.g., in a configurable logic IC) that are configurable by an end user are referred to as “soft logic.” “Hard logic” generally refers to circuits in an integrated circuit device that have substantially less configurable features than soft logic or no configurable features.

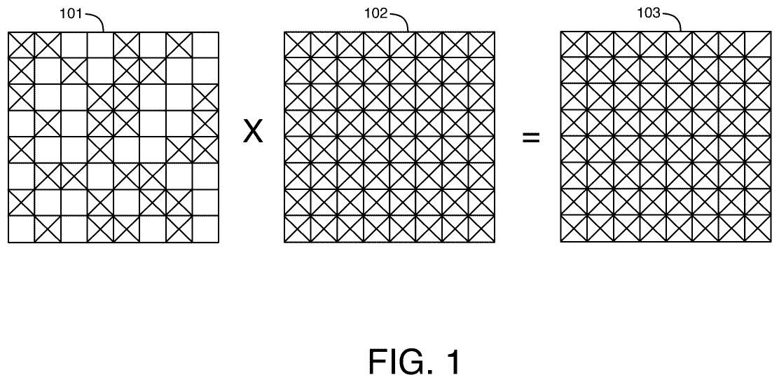

FIG. 1 is a diagram that illustrates examples of a weight matrix 101 that includes sparse weights, an activation matrix 102 that includes dense activations, and an output matrix 103. In the example of Figure (FIG. 1, each of the matrices 101-103 is an 8×8 matrix having 64 values that are represented by square boxes. In FIG. 1, each of the boxes in the matrices having an X represents a non-zero value, and each of the blank boxes in the matrices having no X represents a zero value.

The weight matrix 101 is multiplied by the activation matrix 102 to generate the output matrix 103. As shown in FIG. 1, weight matrix 101 is a sparse weight matrix having 4:2 structured sparsity with 32 non-zero weight values and 32 zero weight values. Each of the matrices 102 and 103 has 64 non-zero values. Thus, matrix 102 is a dense activation matrix, and output matrix 103 is a dense output matrix.

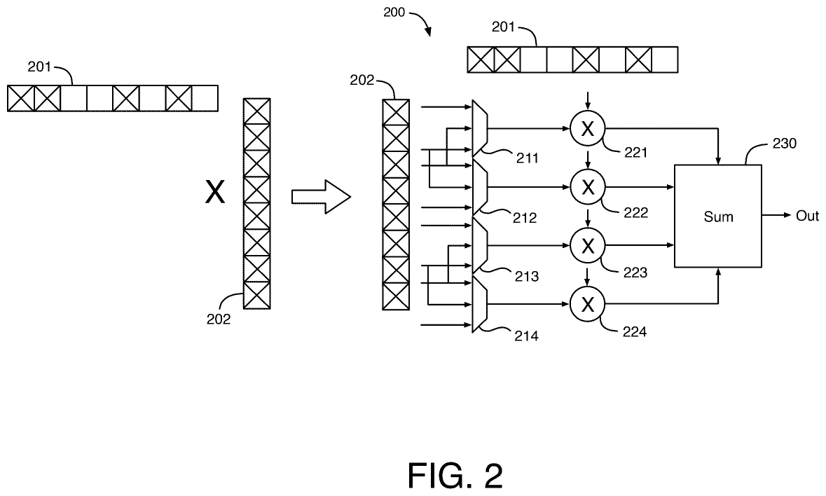

FIG. 2 is a diagram that illustrates an example of a tensor circuit block 200 that includes 4 multiplexer circuits 211-214, 4 multiplier circuits 221-224, and summation (sum) circuit block 230. FIG. 2 also illustrates 2 columns 201-202 of values. Each of the columns 201-202 is a column of a different matrix. Column 201 is a column of a sparse weight matrix (e.g., matrix 101), and column 202 is a column of a dense activation matrix (e.g., matrix 102). Each of the columns 201 and 202 has 2 vectors. Thus, columns 201-202 have two weight vectors and two activation vectors, respectively.

Tensor circuit block 200 multiplies the non-zero values in column 201 by the values in column 202 to generate an output OUT. Because the weights in column 201 are sparse, there are more activation values in column 202 than there are multiplier circuits 221-224. Therefore, the activation values in column 202 are multiplexed by multiplexer circuits 211-214 to be aligned with the non-zero weight values in column 201. The multiplexer circuits 211, 212, 213, and 214 provide the activation values in column 202 to inputs of multiplier circuits 221, 222, 223, and 224, respectively. The selections of the multiplexer circuits 211-214 are controlled by one or more sparsity values that indicate the structured sparsity of the weight values in column 202. Multiplier circuits 221, 222, 223, and 224 multiply the activation values selected by multiplexer circuits 211, 212, 213, and 214, respectively, by the non-zero weight values in column 201 to generate products. The products generated by multiplier circuits 221-224 are provided to inputs of summation circuit block 230. Summation circuit block 230 sums the products generated by multiplier circuits 221-224 to generate an output value OUT.

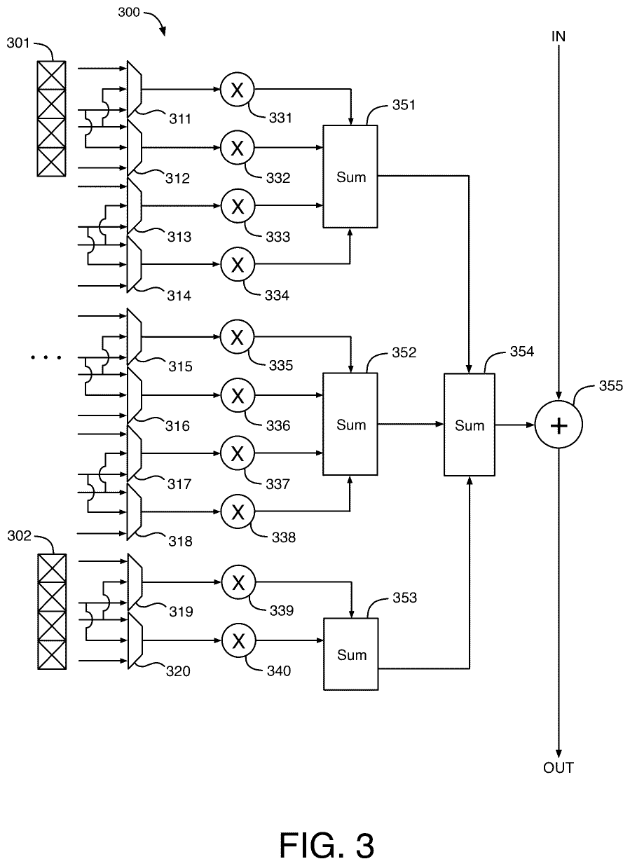

FIG. 3 is a diagram that illustrates an example of a tensor circuit block 300 that includes 10 multiplexer circuits 311-320, 10 multiplier circuits 331-340, and 5 summation (sum) circuit blocks 351-355. Vectors with values from a dense activation matrix are provided to inputs of the multiplexer circuits 311-320. FIG. 3 illustrates 2 of these vectors 301-302 that are from a dense activation matrix (e.g., matrix 102). In the example of FIG. 3, 20 activation values are provided to the tensor circuit block 300 through 160 inputs, where each activation value has 8 bits.

Tensor circuit block 300 multiplies the activation values selected by the multiplexer circuits by the non-zero values from a sparse weight matrix to generate an output OUT. Multiplexer circuits 311-320 provide selected activation values to inputs of multiplier circuits 331-340, respectively. The selection of the multiplexer circuits 311-320 is controlled by sparsity values that indicate the structured sparsity of the weight values. Multiplier circuits 331-340 multiply the activation values selected by the multiplexer circuits 311-320 by the non-zero values from the sparse weight matrix to generate products.

Summation circuit block 351 sums the products generated by multiplier circuits 331-334 to generate a first sum. Summation circuit block 352 sums the products generated by multiplier circuits 335-338 to generate a second sum. Summation circuit block 353 sums the products generated by multiplier circuits 339-340 to generate a third sum. Summation circuit block 354 sums the first, second, and third sums generated by summation circuits 351-353 to generate a fourth sum. Summation circuit block 355 sums the fourth sum generated by circuit block 354 with outputs of additional tensor circuit blocks (not shown) that may have a similar structure as tensor circuit block 300 to generate an output OUT.

Implementing the multiplexer circuits 311-320 in soft logic in an FPGA is typically expensive in terms of routing and logic resources. As an example, 80 2:1 multiplexers (for 10 inputs×2 values) may use 4 logic array blocks (LABs). The cost of the soft logic (i.e., the integrated circuit die area used) may approach the cost of using a digital signal processing (DSP) block. A DSP block can provide twice the logic density, but at a cost of two times the system area requirement.

According to some examples disclosed herein below, registers in a tensor circuit block are used to enable weight sparsity. Rather than storing the weight values in registers in a tensor circuit block and streaming in the activation values to the tensor circuit block, the activation values are instead provided to, and stored in, registers in the tensor circuit block, and the weight values in compressed form are streamed into the tensor circuit block. Thus, the inputs are swapped in these examples.

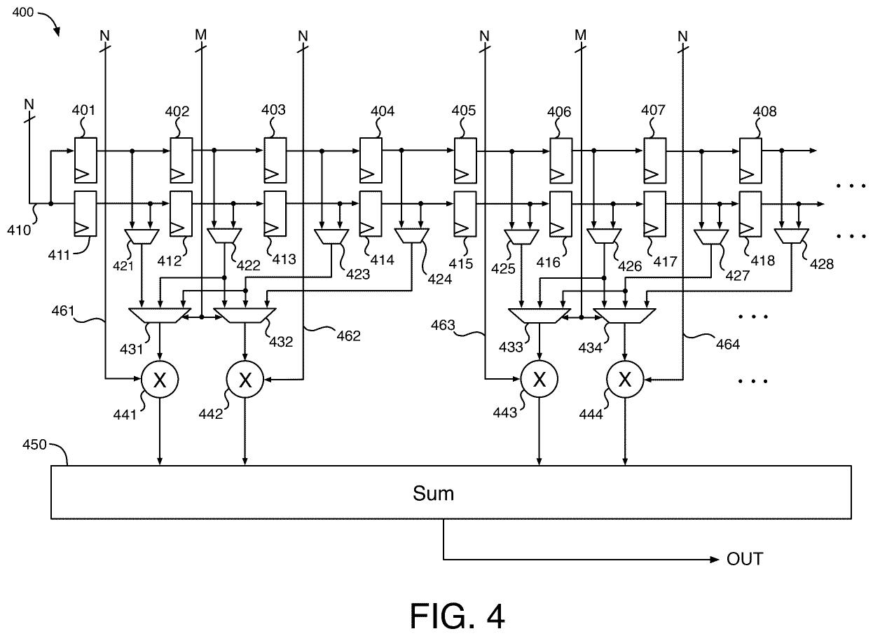

One or more sparsity indices are also streamed into the tensor circuit block. Each weight value has a unique sparsity index (e.g., represented as a 2-bit number). According to an example, each weight (e.g., with 4:2 structured sparsity) is 10-bits, including an 8-bit weight value and a 2 bit sparsity index. The sparsity indices can be encoded per pair of weights, which reduces the number of bits, for example, from 4 bits per pair of weights to 3 bits per pair of weights. As an example, a tensor column in a DSP block can have 8 multipliers and two sets of 10 registers. The architectures disclosed herein with respect to FIGS. 4, 6, and 8 can have 2 banks of 20 registers, as examples.

FIG. 4 is a diagram that illustrates an example of a tensor circuit block 400 that can multiply activation values in an activation matrix by weight values in a sparse weight matrix in a structured sparsity mode. FIG. 4 illustrates 8 register circuits 401-408 coupled in series in a first bank, 8 register circuits 411-418 coupled in series in a second bank, 8 multiplexer circuits 421-428, 4 multiplexer circuits 431-434, 4 multiplier circuits 441-444, and summation (sum) circuit block 450 as examples. However, tensor circuit block 400 can include any number of the register circuits and a corresponding number of the multiplexer circuits and multiplier circuits, as shown by the ellipses in FIG. 4. The tensor circuit block 400 can be fabricated in any type of integrated circuit (IC) die, such as a configurable IC (e.g., a field programmable gate array (FPGA) or programmable logic device (PLD)), a microprocessor IC, a graphics processing unit IC, a memory IC, an application specific IC, a transceiver IC, a memory IC, etc.

FIG. 4 illustrates the structure and operation of the tensor circuit block 400 in structured sparsity mode. Tensor circuit block 400 multiplies activation values from a dense activation matrix by non-zero weight values from a sparse weight matrix to generate an output signal OUT. Sets of the activation values from the dense activation matrix are provided to inputs of register circuits 401 and 411 through N-bit bus 410. Each of the activation values has an N number of bits (e.g., 8-bits), where N is any positive integer. The non-zero weight values from the sparse weight matrix are streamed into the tensor circuit block 400 and are provided to first inputs of the multiplier circuits 441-444 through N-bit busses 461-464, respectively. Each of the weight values has an N number of bits (e.g., 8-bits). The weight values are not stored in registers in tensor circuit block 400.

In addition, sparsity indices are streamed into the tensor circuit block 400. Each of the weight values corresponds to one of the sparsity indices. Each sparse index is a code that indicates the sparsity of one of the weight values. In the example of FIG. 4, each of the sparsity indices encodes the sparsity of two corresponding ones of the weight values. The sparsity indices are coded per pair of the weight values, such that each of the sparsity indices has an M number of bits (e.g., 3 bits per pair of 8-bit weight values), where M is any positive integer. Each M-bit sparsity index is provided to select inputs of two of the multiplexer circuits 431-434 as shown in FIG. 4.

The activation values are alternately loaded into the first bank of register circuits 401-408 and into the second bank of register circuits 411-418 at different times as a ping-pong buffer. Initially, during a first period of time, a first set of the activation values from an activation matrix (e.g., from a vector or column of the activation matrix) are loaded into register circuits 401-408 in response to a clock signal (not shown), until each of the register circuits 401-408 stores a different one of the activation values in the first set. Then, during a second period of time after the first period of time, a second set of the activation values from the activation matrix (e.g., from a different vector or column of the activation matrix) are loaded into register circuits 411-418 in response to the clock signal, until each of the register circuits 411-418 stores a different one of the activation values in the second set. Because each of the activation values is an N-bit (e.g., 8-bit) value, each of the register circuits 401-408 and 411-418 stores an N-bit value.

During the second period of time while the second set of activation values are loaded into register circuits 411-418, multiplexer circuits 421-428 are configured to provide the first set of the activation values stored in register circuits 401-408 to inputs of multiplexer circuits 431-434, as shown in FIG. 4. The multiplexer circuits 431-434 are configured by the M-bit sparsity indices to provide a subset of the activation values stored in register circuits 401-408 to second inputs of multiplier circuits 441-444. Thus, the sparsity indices determine which of the activation values are provided to the multiplier circuits 441-444. The multiplier circuits 441-444 then multiply the subset of the activation values received from the multiplexer circuits 431-434, respectively, by a first set of the respective weight values from the sparse weight matrix received through busses 461-464 to generate products that are provided to summation circuit 450. Summation circuit 450 sums the products generated by multiplier circuits 441-444 to generate a first value in output signal OUT.

Then, during a third period of time after the second period of time, a third set of the activation values from the activation matrix are loaded into register circuits 401-408 in response to the clock signal, until each of the register circuits 401-408 stores a different one of the activation values in the third set. During the third period of time while the third set of activation values are loaded into register circuits 401-408, multiplexer circuits 421-428 are configured to provide the second set of the activation values stored in register circuits 411-418 to inputs of multiplexer circuits 431-434, as shown in FIG. 4. The multiplexer circuits 431-434 are configured by the M-bit sparsity indices to provide a subset of the activation values stored in register circuits 411-418 to the second inputs of multiplier circuits 441-444. The multiplier circuits 441-444 multiply the subset of the activation values received from the multiplexer circuits 431-434, respectively, by a second set of the respective weight values from the sparse weight matrix received through busses 461-464 to generate products that are provided to summation circuit 450. Summation circuit 450 sums the products generated by multiplier circuits 441-444 to generate a second value in output signal OUT.

Then, during a fourth period of time after the third period of time, a fourth set of the activation values are loaded into register circuits 411-418. During the fourth period of time, multiplexer circuits 421-428 are configured to provide the third set of the activation values stored in register circuits 401-408 to inputs of multiplexer circuits 431-434. Multiplexer circuits 431-434 are configured by the sparsity indices. Multiplier circuits 441-444 multiply a third set of the weight values by a subset of the activation values received from the multiplexer circuits 431-434, and the summation circuit 450 sums the products of the multiplier circuits 441-444 to generate an additional value in output signal OUT. This process repeats for each additional set of activation values and each additional set of weight values provided to the tensor circuit block 400 in subsequent time periods. When all of the weight values in a sparse weight matrix have been processed by tensor circuit block 400, weight values from an additional sparse weight matrix are provided to the multiplier circuits 441-444. In addition, activation values from an additional activation matrix are provided to tensor circuit block 400 after all of the activation values from a previous activation matrix have been processed.

According to two alternative implementations, tensor circuit block 400 of FIG. 4 can be modified to add additional multiplexer circuits to support a dense mode for processing a dense weight matrix. According to the first alternative implementation, the multiplexer circuits 431-434 are replaced with 4:1 multiplexer circuits, with the additional data input coupled to the next dense register circuit 401-408 or 411-418. In the structured sparsity mode, inputs for the 3rd and 4th multiplier circuits 443-444 are received from the register circuits having register indexes 5, 6, 7, and 8 (i.e., register circuits 405-408 and 415-418). In the dense mode, inputs for the 3rd and 4th multiplier circuits 443-444 are received from the register circuits 403, 404, 413, and 414 having register indexes 3 and 4. In the structured sparsity mode, inputs for the 9th and 10th multiplier circuits are received from the register circuits having register indexes 17, 18, 19, and 20. In the dense mode in the first alternative implementation, inputs for the 9th and 10th multiplier circuits are received from the register circuits having register indices 9 and 10.

According to the second alternative implementation, while loading a dense set of weight values into the register circuits in dense mode, the 3rd and 4th register circuits in every group of four register circuits in tensor circuit block 400 are skipped over. In the dense mode, registers circuits 401-408 and 411-418 etc. store weight values (e.g., coefficients). In the structured sparsity mode, registers circuits 401-408 and 411-418 etc. store the activation values. The second alternative implementation has an additional 2:1 multiplexer circuit in each bank of serially coupled register circuits that is coupled to every 4th register circuit in each bank of register circuits. As an example, the tensor circuit block 400 can be modified to include four additional 2:1 multiplexer circuits per bank of register circuits or 8 additional multiplexer circuits in total. The routes to skip over 2 of the register circuits are the same length, and the multiplexer circuits 431-434 are 3:1 multiplexer circuits, as shown in FIG. 4. This implementation can provide a more regular circuit layout and may also require fewer logic gates.

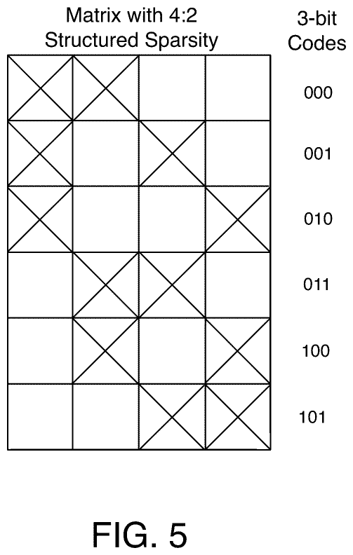

FIG. 5 is a diagram that illustrates examples of 6 different combinations of 4:2 structured sparsity for a matrix and examples of 3-bit binary codes that encode these 6 combinations. Each horizontal row of the matrix of FIG. 5 represents a different one of the 6 combinations of 4:2 structured sparsity. Each of the 3-bit codes of FIG. 5 is an encoding of the 4:2 structured sparsity of a corresponding one of the 6 rows of the matrix shown in FIG. 5. In FIG. 5, each of the boxes in the matrix having an X represents a non-zero value, and each of the blank boxes in the matrix having no X represents a zero value.

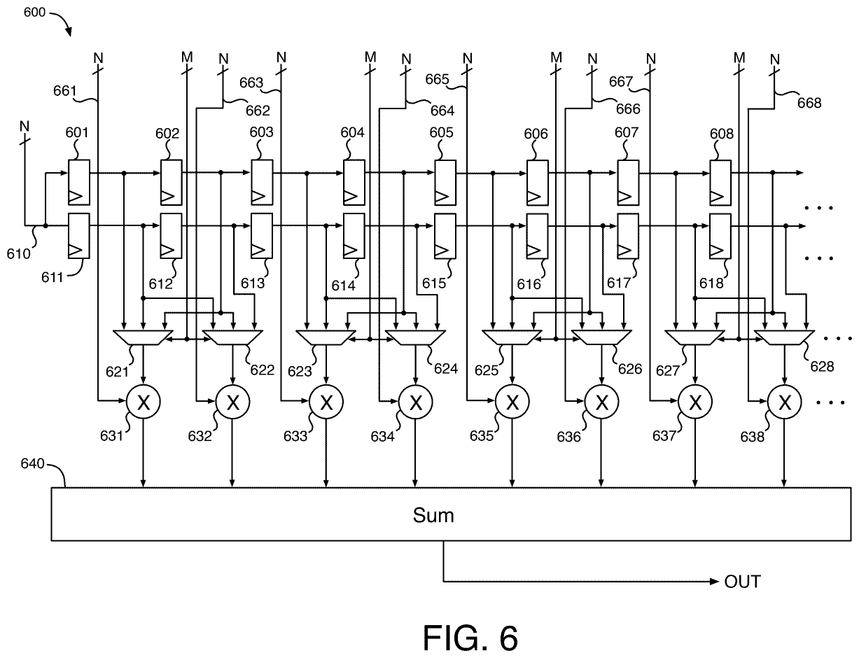

FIG. 6 is a diagram that illustrates another example of a tensor circuit block 600 that can multiply activation values in an activation matrix by weight values in a sparse weight matrix in a structured sparsity mode. FIG. 6 illustrates 8 register circuits 601-608 coupled in series in a first bank, 8 register circuits 611-618 coupled in series in a second bank, 8 3:1 multiplexer circuits 621-628, 8 multiplier circuits 631-638, and summation (sum) circuit block 640 as examples. However, tensor circuit block 600 can include any number of the register circuits and a corresponding number of the multiplexer circuits and multiplier circuits, as shown by the ellipses in FIG. 6. The tensor circuit block 600 can be fabricated in any type of integrated circuit (IC) die, such as a configurable IC, a microprocessor IC, a graphics processing unit IC, a memory IC, an application specific IC, a transceiver IC, a memory IC, etc.

Tensor circuit block 600 only operates in structured sparsity mode. Tensor circuit block 600 multiplies activation values from a dense activation matrix by non-zero weight values from a sparse weight matrix to generate an output signal OUT. Sets of the activation values from the dense activation matrix are provided to inputs of register circuits 601 and 611 through N-bit bus 610. Each of the activation values has an N number of bits (e.g., 8-bits), where N is any positive integer. A set of the weight values from the sparse weight matrix are streamed into tensor circuit block 600 and are provided to first inputs of the multiplier circuits 631-638 through N-bit busses 661-668, respectively. Each of the weight values has an N number of bits (e.g., 8-bits).

Sparsity indices are streamed into the tensor circuit block 600. Each of the sparsity indices encodes the sparsity of two corresponding weight values. The sparsity indices are coded per pair of the weight values, such that each of the sparsity indices has an M number of bits (e.g., 3 bits per pair of 8-bit weight values), where M is any positive integer. Each M-bit sparsity index is provided to select inputs of two of the multiplexer circuits 621-628, as shown in FIG. 6.

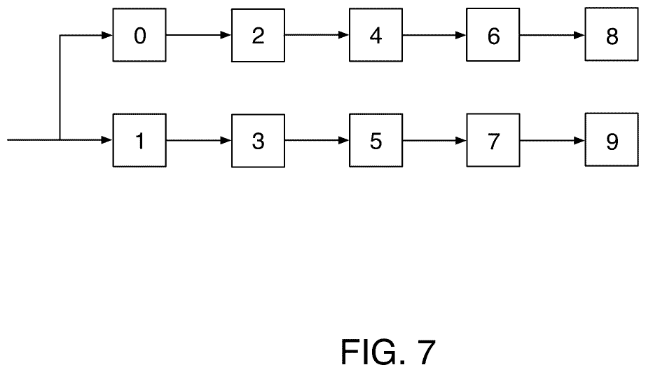

The activation values can be loaded into the register circuits 601-608 and 611-618 in any suitable order. FIG. 7 is a diagram that illustrates an example of an alternating input sequence of activation values loaded into the register circuits 601-608 and 611-618 in the tensor circuit block 600 of FIG. 6 during the structured sparsity mode. Instead of sets of the activation values being loaded into alternating banks of the register circuits as disclosed herein with respect to FIG. 4, the activation values can be alternately loaded into the two banks of the register circuits 601-608 and 611-618 in tensor circuit block 600 as shown in FIG. 7. The numbers 0-9 in FIG. 7 represent the numerical sequence of activation values that are loaded into the register circuits 601-608 and 611-618. The first row of boxes in FIG. 7 with numbers 0, 2, 4, 6, and 8 represents the first bank of register circuits 601-608, and the second row of boxes with numbers 1, 3, 5, 7, and 9 represents the second bank of register circuits 611-618. Initially, the first activation value (0) is loaded into register circuits 601-608, then the second activation value (1) is loaded into register circuits 611-618, then the third activation value (2) is loaded into register circuits 601-608, etc. This technique of alternately loading the activation values into the register circuits as shown in FIG. 7 can be manually accomplished using ping pong load controls, or automatically switched with a load counter, where the least significant bit (LSB) of the load counter enables the appropriate register bank.

Referring to FIG. 6, a set of the activation values from an activation matrix (e.g., one or more vectors) are loaded into register circuits 601-608 and 611-618 in any suitable order (in an alternating manner as shown in FIG. 7), using a clock signal (not shown), until each of the register circuits 601-608 and 611-618 stores a different one of the activation values. In the example of FIG. 6, multiplier circuits 631-638 are idle and do not process input values while activation values are loaded into the register circuits. Multiplier circuits 631-638 can only process input values when all of the activation values in the current set are loaded into both the first and second banks of the register circuits 601-608 and 611-618.

The multiplexer circuits 621-628 are configured by the M-bit sparsity indices to provide a subset of the activation values stored in register circuits 601-608 and 611-618 to second inputs of multiplier circuits 631-638. Thus, the sparsity indices determine which of the activation values are provided by multiplexer circuits 621-628 to the multiplier circuits 631-638. The multiplier circuits 631-638 then multiply the subset of the activation values received from the multiplexer circuits 621-628, respectively, by the respective weight values from the sparse weight matrix received through busses 661-668 to generate products that are provided to summation circuit 640. Summation circuit 640 sums the products generated by multiplier circuits 631-638 to generate an output value in output signal OUT. This process repeats for each additional set of activation values and each additional set of weight values provided to the tensor circuit block 600 in subsequent time periods.

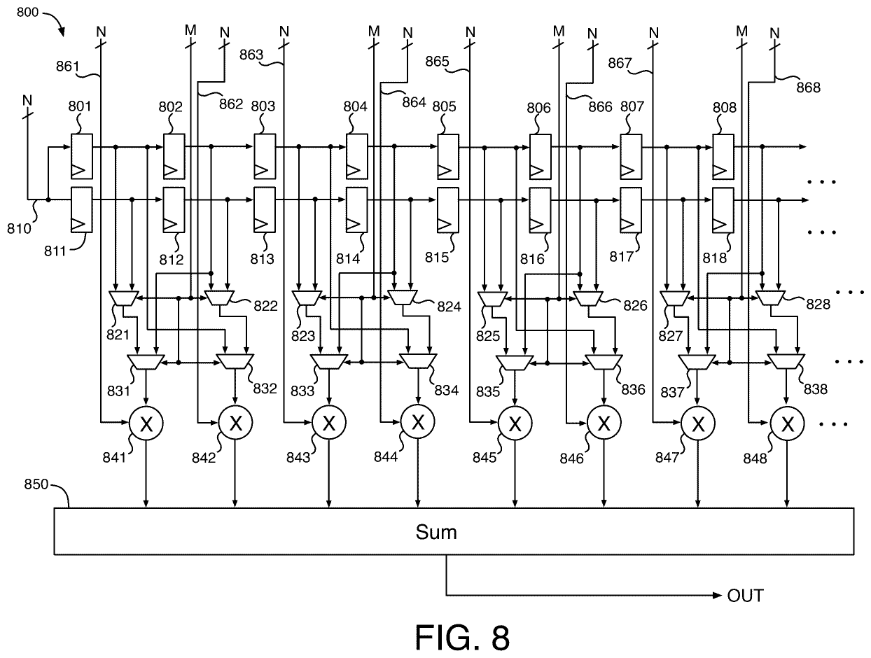

FIG. 8 is a diagram that illustrates another example of a tensor circuit block 800 that can multiply activation values in an activation matrix by weight values in a weight matrix in a structured sparsity mode or in a dense mode. FIG. 8 illustrates 8 register circuits 801-808 coupled in series in a first bank, 8 register circuits 811-818 coupled in series in a second bank, 8 2:1 multiplexer circuits 821-828, 8 2:1 multiplexer circuits 831-838, 8 multiplier circuits 841-848, and summation (sum) circuit block 850 as examples. However, tensor circuit block 800 can include any number of the register circuits and a corresponding number of the multiplexer circuits and multiplier circuits, as shown by the ellipses in FIG. 8. The tensor circuit block 800 can be fabricated in any type of integrated circuit (IC) die, such as a configurable IC (e.g., an FPGA or PLD), a microprocessor IC, a graphics processing unit IC, a memory IC, an application specific IC, a transceiver IC, a memory IC, etc.

Tensor circuit block 800 can operate in structured sparsity mode or in dense mode. In structured sparsity mode, tensor circuit block 800 multiplies activation values from a dense activation matrix by non-zero weight values from a sparse weight matrix to generate an output signal OUT. In dense mode, tensor circuit block 800 multiplies activation values from a dense activation matrix by weight values from a dense weight matrix to generate an output signal OUT.

In structured sparsity mode, sets of the N-bit activation values from the dense activation matrix are loaded into register circuits 801-808 and 811-818 through N-bit bus 810, and a set of the N-bit weight values from the sparse weight matrix are streamed into tensor circuit block 800 and provided to first inputs of the multiplier circuits 841-848 through N-bit busses 861-868.

The M-bit sparsity indices are streamed into the tensor circuit block 800. Each of the sparsity indices encodes the sparsity of two corresponding weight values. Each M-bit sparsity index is provided to select inputs of 4 of the multiplexer circuits 821-828 and 831-838 as shown in FIG. 8.

In structured sparsity mode, a set of the activation values from an activation matrix (e.g., one or more vectors) are loaded into register circuits 801-808 and 811-818 in any suitable order (in an alternating manner as shown in FIG. 7), using a clock signal (not shown), until each of the register circuits 801-808 and 811-818 stores a different one of the activation values. In the example of FIG. 8, multiplier circuits 841-848 are idle and do not process input values while activation values are loaded into the register circuits. The multiplexer circuits 821-828 and 831-838 are configured by the M-bit sparsity indices to provide a subset of the activation values stored in register circuits 801-808 and 811-818 to second inputs of multiplier circuits 841-848. Thus, the sparsity indices determine which of the activation values are provided by multiplexer circuits 821-828 and 831-838 to the multiplier circuits 841-848. The multiplier circuits 841-848 then multiply the subset of the activation values received from the multiplexer circuits 831-838, respectively, by the respective weight values from the sparse weight matrix received through busses 861-868 to generate products that are summed by summation circuit 850 to generate an output value in output signal OUT. This process repeats for each additional set of activation values and each additional set of weight values provided to the tensor circuit block 800 in subsequent time periods.

In dense mode, a set of the N-bit weight values from a dense weight matrix (e.g., one or more vectors) are loaded into register circuits 801-808 and 811-818 using a clock signal, until each of the register circuits 801-808 and 811-818 stores a different one of the weight values, and a set of the N-bit activation values are steamed into tensor circuit block 800 to the first inputs of multiplier circuits 841-848 through busses 861-868. The multiplexer circuits 821-828 and 831-838 are configured by M-bit select values to provide a subset of the weight values stored in register circuits 801-808 and 811-818 to the second inputs of multiplier circuits 841-848. The multiplier circuits 841-848 then multiply the subset of the dense weight values received from the multiplexer circuits 831-838, respectively, by the respective activation values to generate products that are summed by summation circuit 850 to generate an output value in output signal OUT. This process repeats for each additional set of activation values and each additional set of weight values provided to the tensor circuit block 800 in subsequent time periods.

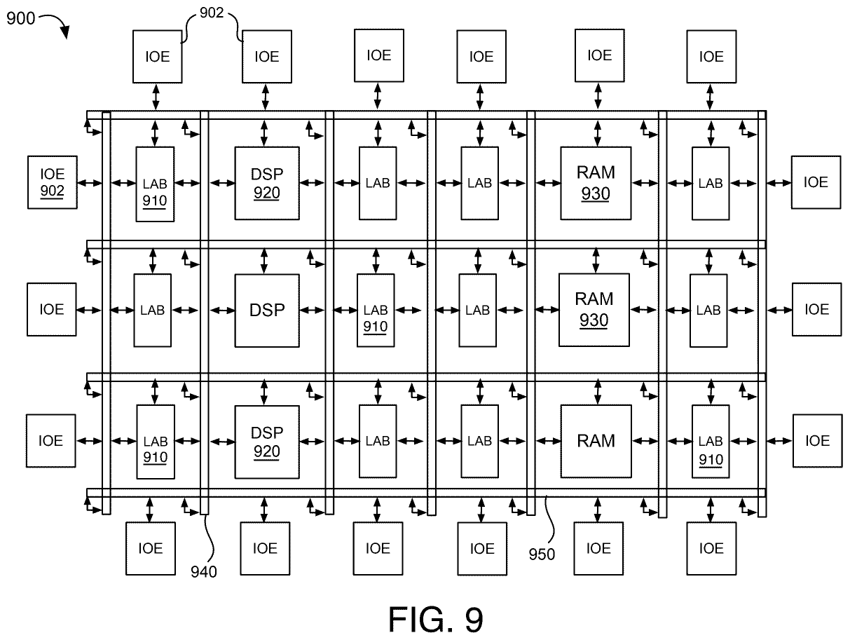

FIG. 9 is a diagram of an illustrative example of a configurable integrated circuit (IC) 900. Configurable IC 900 is an example of an IC that can include any of the circuits and/or perform any of the operations disclosed herein with respect to FIGS. 1-8. As shown in FIG. 9, the configurable integrated circuit 900 includes a two-dimensional array of configurable logic circuit blocks, including logic array blocks (LABs) 910 and other configurable logic circuit blocks, such as random access memory (RAM) blocks 930 and digital signal processing (DSP) blocks 920, for example. DSP blocks 920 can include any of the tensor circuit blocks 400, 600, and 800 disclosed herein with respect to FIGS. 4, 6, and 8. Configurable logic circuit blocks, such as LABs 910, can include smaller configurable logic circuits (e.g., configurable logic elements, configurable logic blocks, or adaptive logic modules (ALMs)) that receive input signals and perform custom functions on the input signals to produce output signals. The LABs 910, DSP blocks 920, and RAM blocks 930 can be located in a fabric region of the IC 900 and can be configured to perform any custom user functions. For example, LABs 910, DSP blocks 920, and RAM blocks 930 can be configured as an accelerator circuit.

The configurable integrated circuit 900 also includes programmable interconnect circuitry in the form of vertical routing channels 940 (i.e., interconnects formed along a vertical axis of configurable integrated circuit 900) and horizontal routing channels 950 (i.e., interconnects formed along a horizontal axis of configurable integrated circuit 900), each routing channel including at least one track to route at least one wire. One or more of the routing channels 940 and/or 950 can be part of a network-on-chip (NOC) having router circuits.

In addition, the configurable integrated circuit 900 has input/output elements (IOEs) 902 for driving signals off of configurable integrated circuit 900 and for receiving signals from other devices. Input/output elements 902 can include parallel input/output circuitry, serial data transceiver circuitry, differential receiver and transmitter circuitry, or other circuitry used to connect one integrated circuit to another integrated circuit. Input/output elements 902 can include general purpose input/output (GPIO) circuitry (e.g., on the top and bottoms edges of IC 900), high-speed input/output (HSIO) circuitry (e.g., on the left edge of IC 900), and on-package input/output (OPIOs) circuitry (e.g., on the right edge of IC 900).

As shown, input/output elements 902 can be located around the periphery of the IC. If desired, the configurable integrated circuit 900 can have input/output elements 902 arranged in different ways. For example, input/output elements 902 can form one or more columns of input/output elements that can be located anywhere on the configurable integrated circuit 900 (e.g., distributed evenly across the width of the configurable integrated circuit). If desired, input/output elements 902 can form one or more rows of input/output elements (e.g., distributed across the height of the configurable integrated circuit). Alternatively, input/output elements 902 can form islands of input/output elements that can be distributed over the surface of the configurable integrated circuit 900 or clustered in selected areas.

Note that other routing topologies, besides the topology of the interconnect circuitry depicted in FIG. 9, can be used. For example, the routing topology can include wires that travel diagonally or that travel horizontally and vertically along different parts of their extent as well as wires that are perpendicular to the device plane in the case of three dimensional integrated circuits, and the driver of a wire can be located at a different point than one end of a wire. The routing topology can include global wires that span substantially all of configurable integrated circuit 900, fractional global wires such as wires that span part of configurable integrated circuit 900, staggered wires of a particular length, smaller local wires, or any other suitable interconnection resource arrangement.

Furthermore, it should be understood that examples disclosed herein may be implemented in any type of integrated circuit. If desired, the functional blocks of such an integrated circuit can be arranged in more levels or layers in which multiple functional blocks are interconnected to form still larger blocks. Other device arrangements can use functional blocks that are not arranged in rows and columns.

Configurable integrated circuit 900 can also contain programmable memory elements. The memory elements can be loaded with configuration data (also called programming data) using input/output elements (IOEs) 902 during configuration mode. Once loaded with configuration data, the memory elements each provide a corresponding static control signal that controls the operation of an associated functional block (e.g., LABs 910, DSP 920, RAM 930, or input/output elements 902). The function blocks (e.g., LABs 910, DSP 920, RAM 930, or input/output elements 902) receive user data, generate user data, and transmit user data to other functional blocks in the IC and to external devices during the user mode to implement the functions of a circuit design for IC 900.

In a typical scenario, the outputs of the loaded memory elements are applied to the gates of field-effect transistors in a functional block to turn certain transistors on or off and thereby configure the logic in the functional block including the routing paths. Programmable logic circuit elements that are controlled in this way include parts of multiplexers (e.g., multiplexers used for forming routing paths in interconnect circuits), look-up tables, logic arrays, AND, OR, NAND, and NOR logic gates, pass gates, etc.

The memory elements can use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory or programmable memory elements.

The programmable memory elements can be organized in a configuration memory array consisting of rows and columns. A data register that spans across all columns and an address register that spans across all rows can receive configuration data. The configuration data can be shifted onto the data register. When the appropriate address register is asserted, the data register writes the configuration data to the configuration memory elements of the row that was designated by the address register.

Configurable integrated circuit 900 can include configuration memory that is organized in sectors, whereby a sector can include the configuration bits that specify the function and/or interconnections of the subcomponents and wires in or crossing that sector. Each sector can include separate data and address registers.

The configurable IC 900 of FIG. 9 is merely one example of an IC that can be used with embodiments disclosed herein. The embodiments disclosed herein can be used with any suitable electronic integrated circuit or system. For example, the embodiments disclosed herein can be used with numerous types of electronic devices such as processor integrated circuits, central processing units, memory integrated circuits, graphics processing unit integrated circuits, application specific standard products (ASSPs), application specific integrated circuits (ASICs), and configurable logic integrated circuits. Examples of configurable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

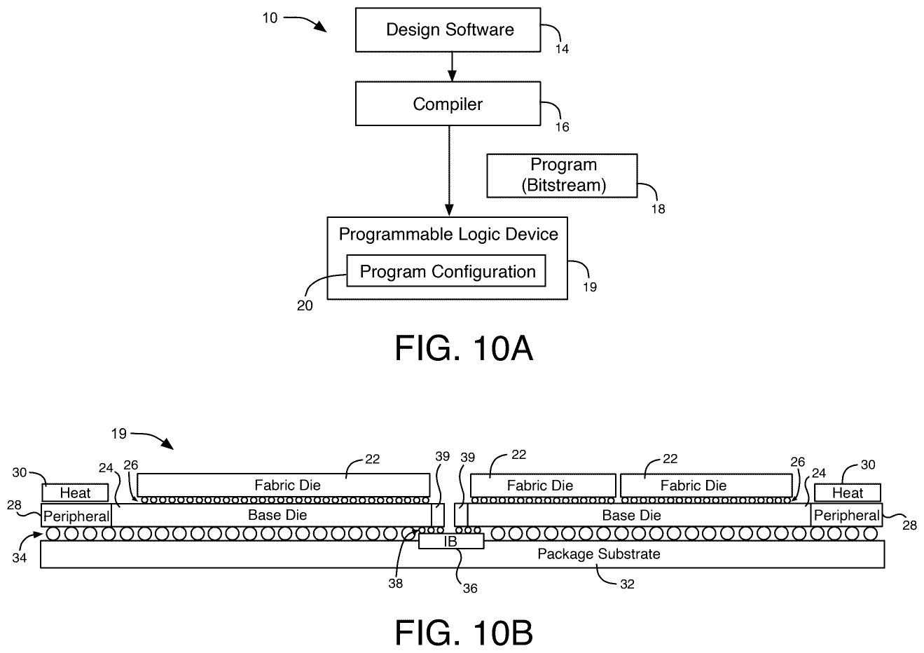

FIG. 10A illustrates a block diagram of a system 10 that can be used to implement a circuit design to be programmed onto a programmable logic device 19 using design software. A designer can implement circuit design functionality on an integrated circuit, such as a reconfigurable programmable logic device 19 (e.g., a field programmable gate array (FPGA)). The designer can implement the circuit design to be programmed onto the programmable logic device 19 using design software 14. The design software 14 can use a compiler 16 to generate a low-level circuit-design program (bitstream) 18, sometimes known as a program object file and/or configuration program, that programs the programmable logic device 19. Thus, the compiler 16 can provide machine-readable instructions representative of the circuit design to the programmable logic device 19. For example, the programmable logic device 19 can receive one or more programs (bitstreams) 18 that describe the hardware implementations that should be stored in the programmable logic device 19. A program (bitstream) 18 can be programmed into the programmable logic device 19 as a configuration program 20. The configuration program 20 can, in some cases, represent an accelerator function to perform for machine learning, video processing, voice recognition, image recognition, or other highly specialized task.

In some implementations, a programmable logic device can be any integrated circuit device that includes a programmable logic device with two separate integrated circuit die where at least some of the programmable logic fabric is separated from at least some of the fabric support circuitry that operates the programmable logic fabric. One example of such a programmable logic device is shown in FIG. 10B, but many others can be used, and it should be understood that this disclosure is intended to encompass any suitable programmable logic device where programmable logic fabric and fabric support circuitry are at least partially separated on different integrated circuit die.

FIG. 10B is a diagram that depicts an example of the programmable logic device 19 that includes three fabric die 22 and two base die 24 that are connected to one another via microbumps 26. In the example of FIG. 10B, at least some of the programmable logic fabric of the programmable logic device 19 is in the three fabric die 22, and at least some of the fabric support circuitry that operates the programmable logic fabric is in the two base die 24. For example, some of the circuitry of configurable IC 900 shown in FIG. 9 (e.g., LABs 910, DSP 920, and RAM 930) can be located in the fabric die 22 and some of the circuitry of IC 900 (e.g., input/output elements 902) can be located in the base die 24.

Although the fabric die 22 and base die 24 appear in a one-to-one relationship or a two-to-one relationship in FIG. 10B, other relationships can be used. For example, a single base die 24 can attach to several fabric die 22, or several base die 24 can attach to a single fabric die 22, or several base die 24 can attach to several fabric die 22 (e.g., in an interleaved pattern). Peripheral circuitry 28 can be attached to, embedded within, and/or disposed on top of the base die 24, and heat spreaders 30 can be used to reduce an accumulation of heat on the programmable logic device 19. The heat spreaders 30 can appear above, as pictured, and/or below the package (e.g., as a double-sided heat sink). The base die 24 can attach to a package substrate 32 via conductive bumps 34. In the example of FIG. 10B, two pairs of fabric die 22 and base die 24 are shown communicatively connected to one another via an interconnect bridge 36 (e.g., an embedded multi-die interconnect bridge (EMIB)) and microbumps 38 at bridge interfaces 39 in base die 24.

In combination, the fabric die 22 and the base die 24 can operate in combination as a programmable logic device 19 such as a field programmable gate array (FPGA). It should be understood that an FPGA can, for example, represent the type of circuitry, and/or a logical arrangement, of a programmable logic device when both the fabric die 22 and the base die 24 operate in combination. Moreover, an FPGA is discussed herein for the purposes of this example, though it should be understood that any suitable type of programmable logic device can be used.

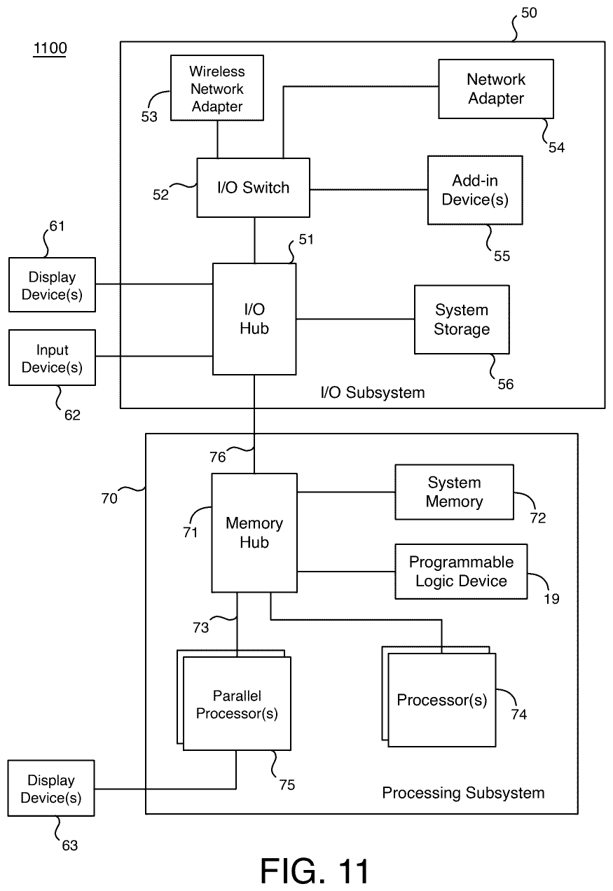

FIG. 11 is a block diagram illustrating a computing system 1100 configured to implement one or more aspects of the embodiments described herein. The computing system 1100 includes a processing subsystem 70 having one or more processor(s) 74, a system memory 72, and a programmable logic device 19 communicating via an interconnection path that can include a memory hub 71. The memory hub 71 can be a separate component within a chipset component or can be integrated within the one or more processor(s) 74. The memory hub 71 couples with an input/output (I/O) subsystem 50 via a communication link 76. The I/O subsystem 50 includes an input/output (I/O) hub 51 that can enable the computing system 1100 to receive input from one or more input device(s) 62. Additionally, the I/O hub 51 can enable a display controller, which can be included in the one or more processor(s) 74, to provide outputs to one or more display device(s) 61. In one embodiment, the one or more display device(s) 61 coupled with the I/O hub 51 can include a local, internal, or embedded display device.

In one embodiment, the processing subsystem 70 includes one or more parallel processor(s) 75 coupled to memory hub 71 via a bus or other communication link 73. The communication link 73 can use one of any number of standards based communication link technologies or protocols, such as, but not limited to, PCI Express, or can be a vendor specific communications interface or communications fabric. In one embodiment, the one or more parallel processor(s) 75 form a computationally focused parallel or vector processing system that can include a large number of processing cores and/or processing clusters, such as a many integrated core (MIC) processor. In one embodiment, the one or more parallel processor(s) 75 form a graphics processing subsystem that can output pixels to one of the one or more display device(s) 61 coupled via the I/O Hub 51. The one or more parallel processor(s) 75 can also include a display controller and display interface (not shown) to enable a direct connection to one or more display device(s) 63.

Within the I/O subsystem 50, a system storage unit 56 can connect to the I/O hub 51 to provide a storage mechanism for the computing system 1100. An I/O switch 52 can be used to provide an interface mechanism to enable connections between the I/O hub 51 and other components, such as a network adapter 54 and/or a wireless network adapter 53 that can be integrated into the platform, and various other devices that can be added via one or more add-in device(s) 55. The network adapter 54 can be an Ethernet adapter or another wired network adapter. The wireless network adapter 53 can include one or more of a Wi-Fi, Bluetooth, near field communication (NFC), or other network device that includes one or more wireless radios.

The computing system 1100 can include other components not shown in FIG. 11, including other port connections, optical storage drives, video capture devices, and the like, that can also be connected to the I/O hub 51. Communication paths interconnecting the various components in FIG. 11 can be implemented using any suitable protocols, such as PCI (Peripheral Component Interconnect) based protocols (e.g., PCI-Express), or any other bus or point-to-point communication interfaces and/or protocol(s), such as the NV-Link high-speed interconnect, or interconnect protocols known in the art.

In one embodiment, the one or more parallel processor(s) 75 incorporate circuitry optimized for graphics and video processing, including, for example, video output circuitry, and constitutes a graphics processing unit (GPU). In another embodiment, the one or more parallel processor(s) 75 incorporate circuitry optimized for general purpose processing, while preserving the underlying computational architecture. In yet another embodiment, components of the computing system 1100 can be integrated with one or more other system elements on a single integrated circuit. For example, the one or more parallel processor(s) 75, memory hub 71, processor(s) 74, and I/O hub 51 can be integrated into a system on chip (SoC) integrated circuit. Alternatively, the components of the computing system 1100 can be integrated into a single package to form a system in package (SIP) configuration. In one embodiment, at least a portion of the components of the computing system 1100 can be integrated into a multi-chip module (MCM), which can be interconnected with other multi-chip modules into a modular computing system.

The computing system 1100 shown herein is illustrative. Other variations and modifications are also possible. The connection topology, including the number and arrangement of bridges, the number of processor(s) 74, and the number of parallel processor(s) 75, can be modified as desired. For instance, in some embodiments, system memory 72 is connected to the processor(s) 74 directly rather than through a bridge, while other devices communicate with system memory 72 via the memory hub 71 and the processor(s) 74. In other alternative topologies, the parallel processor(s) 75 are connected to the I/O hub 51 or directly to one of the one or more processor(s) 74, rather than to the memory hub 71. In other embodiments, the I/O hub 51 and memory hub 71 can be integrated into a single chip. Some embodiments can include two or more sets of processor(s) 74 attached via multiple sockets, which can couple with two or more instances of the parallel processor(s) 75.

Some of the particular components shown herein are optional and may not be included in all implementations of the computing system 1100. For example, any number of add-in cards or peripherals can be supported, or some components can be eliminated. Furthermore, some architectures can use different terminology for components similar to those illustrated in FIG. 11. For example, the memory hub 71 can be referred to as a Northbridge in some architectures, while the I/O hub 51 can be referred to as a Southbridge.

Additional examples are now described. Example 1 is a tensor circuit comprising: first storage circuits coupled to store first activation values from an activation matrix; second storage circuits coupled to store second activation values from the activation matrix; first multiplexer circuits configurable to output a subset of the first and the second activation values stored in the first and the second storage circuits; multiplier circuits coupled to multiply first weight values from a sparse weight matrix by the subset of the first and the second activation values output by the first multiplexer circuits to generate products; and a summation circuit coupled to sum the products.

In Example 2, the tensor circuit of Example 1, wherein the first multiplexer circuits are configured based on sparsity indices that indicate the sparsity of the first weight values from the sparse weight matrix.

In Example 3, the tensor circuit of any one of Examples 1-2, wherein the multiplier circuits multiply a first subset of the first weight values by a subset of the first activation values stored in the first storage circuits to generate a first subset of the products concurrently with the second activation values being loaded into the second storage circuits.

In Example 4, the tensor circuit of Example 3, wherein the multiplier circuits multiply a second subset of the first weight values by a subset of the second activation values stored in the second storage circuits to generate a second subset of the products concurrently with third activation values being loaded into the first storage circuits.

In Example 5, the tensor circuit of any one of Examples 1˜4 further comprises: second multiplexer circuits configurable to output the first activation values stored in the first storage circuits or the second activation values stored in the second storage circuits to the first multiplexer circuits.

In Example 6, the tensor circuit of any one of Examples 1-5, wherein the first weight values are streamed to inputs of the multiplier circuits during a structured sparsity mode without being stored within the tensor circuit.

In Example 7, the tensor circuit of any one of Examples 1-6, wherein the first storage circuits store second weight values from a dense weight matrix during a dense mode, the second storage circuits store third weight values from the dense matrix during the dense mode, the first multiplexer circuits are configurable to output a subset of the second and the third weight values during the dense mode, wherein third activation values are streamed into the tensor circuit, and the multiplier circuits multiply the third activation values by the subset of the second and the third weight values output by the first multiplexer circuits to generate additional products.

In Example 8, the tensor circuit of any one of Examples 1-7, wherein the first storage circuits are first register circuits coupled in series, wherein the second storage circuits are second register circuits coupled in series, wherein the tensor circuit is configurable to load a first half of a single set of activations into the first storage circuits and a second half of the single set of the activations into the second storage circuits, and wherein the tensor circuit is further configurable to load the single set of the activations into both the first and the second storage circuits in an alternating sequence.

In Example 9, the tensor circuit of any one of Examples 1-8, wherein the first and the second storage circuits comprise multiple sets of registers to store individual sets of activations, and wherein the tensor circuit processes a first one of the sets of the activations received from a first one of the sets of the registers unimpeded while a second one of the sets of the registers is loaded with a second one of the sets of the activations.

Example 10 is a method for multiplying weight values from a sparse weight matrix by first and second activation values from an activation matrix, the method comprising: loading the first activation values from the activation matrix into first storage circuits; loading the second activation values from the activation matrix into second storage circuits; configuring first multiplexer circuits to select a subset of the first and the second activation values stored in the first and the second storage circuits; multiplying the weight values from the sparse weight matrix by the subset of the first and the second activation values selected by the first multiplexer circuits using multiplier circuits to generate products; and summing the products using a summation circuit.

In Example 11, the method of Example 10 further comprises: configuring the first multiplexer circuits using sparsity indices that indicate the sparsity of the weight values from the sparse weight matrix.

In Example 12, the method of any one of Examples 10-11 further comprises: configuring second multiplexer circuits to provide the first activation values stored in the first storage circuits to the first multiplexer circuits during a first period of time; and configuring the second multiplexer circuits to provide the second activation values stored in the second storage circuits to the first multiplexer circuits during a second period of time after the first period of time.

In Example 13, the method of any one of Examples 10-12 further comprises: providing the weight values to inputs of the multiplier circuits during a structured sparsity mode without storing the weight values in response to a clock signal that clocks the first and the second storage circuits.

In Example 14, the method of any one of Examples 10-13, wherein the multiplier circuits stops multiplying values while one set of the first and the second activation values are loaded into the first and the second storage circuits.

In Example 15, the method of any one of Examples 10-14, wherein multiplying the weight values by the subset of the first and the second activation values using the multiplier circuits to generate the products further comprises multiplying the weight values by a subset of the first activation values stored in the first storage circuits to generate the products concurrently with the second activation values being loaded into the second storage circuits.

Example 16 is an integrated circuit comprising: a first bank of first register circuits coupled in series to store first activation values from an activation matrix; a second bank of second register circuits coupled in series to store second activation values from the activation matrix; first multiplexer circuits configurable to select a subset of the first and the second activation values; and multiplier circuits that multiply sparse weight values from a sparse weight matrix by the subset of the first and the second activation values selected by the first multiplexer circuits to generate products.

In Example 17, the integrated circuit of Example 16 further comprises: a summation circuit that sums the products received from the multiplier circuits to generate a sum.

In Example 18, the integrated circuit of any one of Examples 16-17, wherein the first multiplexer circuits receive sparsity indices at select inputs that indicate the sparsity of the sparse weight values from the sparse weight matrix.

In Example 19, the integrated circuit of any one of Examples 16-18 further comprises: second multiplexer circuits configurable to provide the first activation values stored in the first bank of the first register circuits to the first multiplexer circuits during a first period of time and the second activation values stored in the second bank of the second register circuits to the first multiplexer circuits during a second period of time after the first period of time.

In Example 20, the integrated circuit of any one of Examples 16-19, wherein the multiplier circuits multiply the sparse weight values by a subset of the first activation values stored in the first bank of the first register circuits to generate the products concurrently with the second activation values being loaded into the second bank of the second register circuits.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

What is claimed is:

1. A tensor circuit comprising:
first storage circuits coupled to store first activation values from an activation matrix;
second storage circuits coupled to store second activation values from the activation matrix;
first multiplexer circuits configurable to output a subset of the first and the second activation values stored in the first and the second storage circuits;
multiplier circuits coupled to multiply first weight values from a sparse weight matrix by the subset of the first and the second activation values output by the first multiplexer circuits to generate products; and
a summation circuit coupled to sum the products.

2. The tensor circuit of claim 1, wherein the first multiplexer circuits are configured based on sparsity indices that indicate the sparsity of the first weight values from the sparse weight matrix.

3. The tensor circuit of claim 1, wherein the multiplier circuits multiply a first subset of the first weight values by a subset of the first activation values stored in the first storage circuits to generate a first subset of the products concurrently with the second activation values being loaded into the second storage circuits.

4. The tensor circuit of claim 3, wherein the multiplier circuits multiply a second subset of the first weight values by a subset of the second activation values stored in the second storage circuits to generate a second subset of the products concurrently with third activation values being loaded into the first storage circuits.

5. The tensor circuit of claim 1 further comprising:
second multiplexer circuits configurable to output the first activation values stored in the first storage circuits or the second activation values stored in the second storage circuits to the first multiplexer circuits.

6. The tensor circuit of claim 1, wherein the first weight values are streamed to inputs of the multiplier circuits during a structured sparsity mode without being stored within the tensor circuit.

7. The tensor circuit of claim 1, wherein the first storage circuits store second weight values from a dense weight matrix during a dense mode, the second storage circuits store third weight values from the dense matrix during the dense mode, the first multiplexer circuits are configurable to output a subset of the second and the third weight values during the dense mode, wherein third activation values are streamed into the tensor circuit, and the multiplier circuits multiply the third activation values by the subset of the second and the third weight values output by the first multiplexer circuits to generate additional products.

8. The tensor circuit of claim 1, wherein the first storage circuits are first register circuits coupled in series, wherein the second storage circuits are second register circuits coupled in series, wherein the tensor circuit is configurable to load a first half of a single set of activations into the first storage circuits and a second half of the single set of the activations into the second storage circuits, and wherein the tensor circuit is further configurable to load the single set of the activations into both the first and the second storage circuits in an alternating sequence.

9. The tensor circuit of claim 1, wherein the first and the second storage circuits comprise multiple sets of registers to store individual sets of activations, and wherein the tensor circuit processes a first one of the sets of the activations received from a first one of the sets of the registers unimpeded while a second one of the sets of the registers is loaded with a second one of the sets of the activations.

10. A method for multiplying weight values from a sparse weight matrix by first and second activation values from an activation matrix, the method comprising:
loading the first activation values from the activation matrix into first storage circuits;
loading the second activation values from the activation matrix into second storage circuits;
configuring first multiplexer circuits to select a subset of the first and the second activation values stored in the first and the second storage circuits;
multiplying the weight values from the sparse weight matrix by the subset of the first and the second activation values selected by the first multiplexer circuits using multiplier circuits to generate products; and
summing the products using a summation circuit.

11. The method of claim 10 further comprising:
configuring the first multiplexer circuits using sparsity indices that indicate the sparsity of the weight values from the sparse weight matrix.

12. The method of claim 10 further comprising:
configuring second multiplexer circuits to provide the first activation values stored in the first storage circuits to the first multiplexer circuits during a first period of time; and
configuring the second multiplexer circuits to provide the second activation values stored in the second storage circuits to the first multiplexer circuits during a second period of time after the first period of time.

13. The method of claim 10 further comprising:
providing the weight values to inputs of the multiplier circuits during a structured sparsity mode without storing the weight values in response to a clock signal that clocks the first and the second storage circuits.

14. The method of claim 10, wherein the multiplier circuits stops multiplying values while one set of the first and the second activation values are loaded into the first and the second storage circuits.

15. The method of claim 10, wherein multiplying the weight values by the subset of the first and the second activation values using the multiplier circuits to generate the products further comprises multiplying the weight values by a subset of the first activation values stored in the first storage circuits to generate the products concurrently with the second activation values being loaded into the second storage circuits.

16. An integrated circuit comprising:
a first bank of first register circuits coupled in series to store first activation values from an activation matrix;
a second bank of second register circuits coupled in series to store second activation values from the activation matrix;
first multiplexer circuits configurable to select a subset of the first and the second activation values; and
multiplier circuits that multiply sparse weight values from a sparse weight matrix by the subset of the first and the second activation values selected by the first multiplexer circuits to generate products.

17. The integrated circuit of claim 16 further comprising:
a summation circuit that sums the products received from the multiplier circuits to generate a sum.

18. The integrated circuit of claim 16, wherein the first multiplexer circuits receive sparsity indices at select inputs that indicate sparsity of the sparse weight values from the sparse weight matrix.

19. The integrated circuit of claim 16 further comprising:
second multiplexer circuits configurable to provide the first activation values stored in the first bank of the first register circuits to the first multiplexer circuits during a first period of time and the second activation values stored in the second bank of the second register circuits to the first multiplexer circuits during a second period of time after the first period of time.

20. The integrated circuit of claim 16, wherein the multiplier circuits multiply the sparse weight values by a subset of the first activation values stored in the first bank of the first register circuits to generate the products concurrently with the second activation values being loaded into the second bank of the second register circuits.
